(19) United States
(12) Patent Application Publication
(10) Pub. No.: US 2021/0336773 A1
(43) Pub. Date: Oct. 28, 2021

(54) METHOD FOR VERIFYING THE AUTHENTIC ORIGIN OF ELECTRONIC MODULES OF A MODULAR FIELD DEVICE IN AUTOMATION TECHNOLOGY

(71) Applicant: Endress+Hauser Conducta GmbH+Co. KG, Gerlingen (DE)

(72) Inventor: Thomas Alber, Stuttgart (DE)

(21) Appl. No.: 17/237,546

(22) Filed: Apr. 22, 2021

(30) Foreign Application Priority Data
Apr. 22, 2020 (DE) 10 2020 111 020.0

(51) Int. Cl. H04L 9/08; H04L 9/32

(52) U.S. Cl. CPC H04L 9/0825; H04L 9/0894; H04L 9/0866; H04L 9/3236; H04L 9/3247

(57) ABSTRACT

The present disclosure relates to a method for verifying the origin of electronic modules of a field device. Each manufacturer of an electronic module classified as trustworthy is assigned a key pair. Public keys classified as trustworthy are stored in a list in the field device. Each electronic module contains the public key of the manufacturer and a manufacturer signature. The manufacturer signature confirms the public key as trustworthy. When an electronic module is exchanged or added, the field device checks whether that module has a key pair and a manufacturer signature, whether the public key of the manufacturer of the electronic module is listed in the list with the public keys of the manufacturers classified as trustworthy, whether the manufacturer signature matches the manufacturer and the electronic module, and whether the electronic module is in possession of a correct private key.

### CROSS-REFERENCE TO RELATED APPLICATION

The present application is related to and claims the priority benefit of German Patent Application No. 10 2020 111 020.0, filed on Apr. 22, 2020, the entire contents of which are incorporated herein by reference.

### TECHNICAL FIELD

The present disclosure relates to a method for verifying the authentic origin of electronic modules of a modular field device in automation technology.

### BACKGROUND

Field devices for detecting and/or influencing physical, chemical, or biological process variables are often used in process automation as well as in manufacturing automation. Measuring devices are used for detecting process variables. These measuring devices are used, for example, for pressure and temperature measurement, conductivity measurement, flow measurement, pH measurement, fill level measurement, etc., and detect the corresponding process variables of pressure, temperature, conductivity, pH value, fill level, flow, etc. Actuator systems are used for influencing process variables. Examples of actuators are pumps or valves that can influence the flow of a fluid in a pipe or the fill level in a tank. In addition to the aforementioned measuring devices and actuators, field devices are also understood to include remote I/Os, radio adapters, or, generally, devices that are arranged at the field level. In connection with the present disclosure, all devices which are used in the vicinity of the process or of the plant and which supply or process the information relevant to the process or plant are referred to as field devices.

Corresponding field devices usually consist of a multiplicity of electronic modules, such as plug-in modules with circuit boards, sensors with a digital connection, etc. If an electronic module is exchanged or added, currently there is no check as to whether the electronic module is authentic with regard to its origin, i.e. whether an electronic assembly originates from an original manufacturer or from a manufacturer classified as trustworthy—and is also capable of proving this. The authenticity of the origin of an electronic module has hitherto not been reliably verified prior to installation. At best, a visual check is carried out if the installation is carried out by a service technician who is skilled in the art. If the visual inspection is positive, it is assumed that the electronic module can be installed in the field device.

The procedure described above poses a considerable safety risk: Because, in principle, there has until now been no possibility of detecting an electronic module which has been brought to market by an unauthorized manufacturer, there is the risk that electronic modules will come into use in field devices which do not meet the required security regulations. If an electronic module, for example, does not meet the requirements for use in an explosion hazard area, but is used in automation technology in such an area, it can have absolutely life-threatening effects.

### SUMMARY

The object of the present disclosure is to propose a method by means of which it is ensured that only electronic modules originating from authorized manufacturers can be functionally used in field devices in automation technology.

The present disclosure is achieved by a method for verifying the authentic origin of electronic modules of a modular field device in automation technology, wherein each manufacturer of an electronic module of the field device classified as trustworthy is assigned a key pair consisting of a public key and a private key, and wherein the public keys of the manufacturers classified as trustworthy are stored in a list in the field device or in a unit communicating with the field device. In addition to a key pair identifying the electronic module, consisting of a public key and a private key, each electronic module of the field device contains the manufacturer's public key and a manufacturer signature with which the public key of the electronic module is confirmed as trustworthy. The manufacturer signature is the encryption of the public key of the electronic module with the private key of the authorized manufacturer. Alternatively, it is also possible for the manufacturer signature to be generated directly or indirectly via what is known as a digital signature algorithm (DSA, ECDSA or the like). The method has the following method steps:

when exchanging or when adding an electronic module, the field device or the unit communicating with the field device checks:
whether the exchanged or added electronic module has a key pair and a manufacturer signature,
whether the public key of the manufacturer of the electronic module is listed in the list with the public keys of the manufacturers classified as trustworthy; it is also possible to store in the list an additional form of identity associated with the public key of the relevant manufacturer. This can be advantageous if the form of identity is selected in such a way that it requires less memory space than the manufacturer's public key and can thus be transmitted more quickly.
whether the manufacturer signature matches the manufacturer and the electronic module, i.e. whether the electronic module actually originates from the trustworthy manufacturer, and
whether the electronic module is in possession of the correct private key.

A communication or interaction of the exchanged or added electronic module with the field device or another electronic module relating to the functionality of the field device is permitted if the check is concluded with a positive result.

The electronic modules are plug-in modules with circuit boards or sensors with digital connection. These are preferably intelligent sensors, for example Memosens sensors, which are connected to a central converter via pluggable cables. The sensors are, for example, pH sensors, turbidity sensors, conductivity sensors, etc. Suitable converters are sold and distributed by the applicant, for example under the designation CM42, CM44 or Liquiline. The method according to the present disclosure is well suited to ensure that only sensors of authorized manufacturers are connected to the converter/transmitter. Depending on the use case, pH sensors must be calibrated at greater or lesser time intervals. The calibration is usually performed using a PC application (e.g., Memobase Plus of the applicant) in the laboratory; the calibration data determined are stored in the associated sensor. Here as well, the method according to the present disclosure can advantageously be used to differentiate sensors of authorized manufacturers from fake sensors.

In summary, it can be said that, according to the present disclosure, a check is made to determine a) whether the manufacturers of the electronic modules are trustworthy and

b) whether the modules were also actually manufactured by the trustworthy manufacturers. Or, in other words: An electronic module of a manufacturer recognized as trustworthy is accepted if the electronic module is able to verify that it has also actually been manufactured by this manufacturer. In connection with the present disclosure, manufacturer signature means, for example, the encryption of the public key of the electronic module with the manufacturer's private key. As already mentioned above, other signature methods can also be used, such as, for example, DSA, ECDSA, etc. The creation can also be accomplished using additional intermediate steps, such as, for example, using a hash (SHA256). By means of the signature, a manufacturer confirms the origin of the public keys of the electronic modules from its production.

If one wishes to ensure that an electronic module is used only in field devices of authorized manufacturers, a list of manufacturers of field devices classified as trustworthy can be stored in the electronic module. Only if the electronic module can ensure that it is used in a trustworthy field device does it provide its (full) functionality.

In order to check whether the manufacturer signature matches the manufacturer and the exchanged or added electronic module, the manufacturer signature, the manufacturer's public key and the public key of the electronic module are read out and checked. If the manufacturer signature of the exchanged or added electronic module can be decrypted with the manufacturer's public key, it is ensured that the public key of the electronic module originates from a trustworthy manufacturer. Preferably, the corresponding check is carried out as to whether the exchanged or added electronic module with which the field device or the unit communicates and the public key of the electronic module also actually belong together via a challenge/response method. In this case, an arbitrary message is sent from the field device or alternatively with the unit communicating with the field device as a challenge to the exchanged or added electronic module requesting signature creation or encryption with the private key. The exchanged or added electronic module signs or encrypts the message with its private key and returns the signed message as a response to the field device or the unit. The field device or the unit decrypts the signed message using the public key of the exchanged or added electronic module and receives the message back upon positive verification. Alternatively, it is also possible that the message is first hashed and then encrypted with the private key of the electronic module. This is advantageous if long messages or messages of unknown/variable length are communicated. By hashing, the messages, among other things, can be brought to a defined length.

According to a further development of the method according to the present disclosure, the following method step is proposed:

If the check indicates that the exchanged or added electronic module has no manufacturer signature or no key pair, a check is made as to whether a manufacturer signature and/or a key pair for the electronic module can be generated or provided. In the event that the manufacturer signature and/or the key pair can be provided or generated, the manufacturer signature and/or the key pair is transferred to the exchanged or added electronic module. Note the following: The private keys of the authorized manufacturers are of course to be kept secret by the manufacturers; therefore, they are not available in the field device. If an electronic module has no key pair, the key pair can be generated and assigned to the electronic module if a corresponding generator is present. If the manufacturer signature is missing, by way of substitution the field device can do what the manufacturer itself normally does: It acts as a manufacturer with the public key Q of the field device and vouches for the public key of the electronic module by creating a signature q(Pk) using the private key q of the field device. In this case, it is of course necessary for the public key Q of the field device to be listed as a quasi manufacturer in the list of manufacturers classified as trustworthy.

Furthermore, the following method step is provided: In the event that the electronic module has no manufacturer signature and/or no suitable key pair, or that no manufacturer signature and/or no suitable key pair can be generated for the electronic module, the electronic module remains excluded from the communication of the field device.

A preferred embodiment provides the following method step: If the check indicates that the exchanged or added electronic module has the manufacturer signature and the appropriate key pair, but that the manufacturer's public key is not stored in the list, the manufacturer's public key is assigned to the list if an authorized person, for example, a service technician, confirms the trustworthiness of the manufacturer of the electronic module.

Furthermore, the following is proposed: If a manufacturer signature q(Pk) and a suitable key pair (Pk, pk) can be generated for the electronic module, the data are assigned to the electronic module or stored in the electronic module.

In connection with the present disclosure, it is provided that the electronic modules are each provided with a suitable key pair by an authorized manufacturer, the original manufacturer or a third party authorized by the original manufacturer during the production process; furthermore, the public keys of the authorized manufacturers are stored in the list of the manufacturers classified as trustworthy. The generation of the key pairs and the manufacturer signatures of the electronic modules usually takes place in the production of the manufacturer. Only in this way can it be ensured that the private keys of the manufacturers are kept secret. Otherwise, the signature—that is, the encryption with the manufacturer's private key—would lose its effect or significance.

During a service visit on site, however, a further manufacturer can be added to the list of manufacturers classified as trustworthy in certain circumstances. This can happen, for example, in such a way that an authorized person logs into the field device and actively writes the public key of an additional manufacturer into the list or adopts it from one of the plugged-in electronic modules. Furthermore, it is possible for the additional manufacturer to contact a manufacturer already recorded in the list, such as the original manufacturer, and ask this manufacturer, for example, to create an add vendor ticket, which the additional manufacturer can then add to all its electronic modules. Such a ticket must contain the additional manufacturer's public key signed by an authorized manufacturer, whereby the authorized manufacturer vouches for the additional manufacturer's public key.

Furthermore, it is provided that when an electronic module is exchanged, the public key of the authorized manufacturer is deleted from the list if this manufacturer has not provided any further electronic modules of the field device.

The check is preferably carried out during ongoing operation of the field device. This check can also be carried out after a restart of the field device or cyclically according to arbitrarily predetermined time intervals.

As already mentioned, it is also possible to use a derivation, for example a hash value, or some other independent and unique identification, instead of the public key of the authorized manufacturer.

It is also possible to calculate the manufacturer signature using an additional intermediate step: For example, a hash value of the public key of the electronic module is determined before encryption with the manufacturer's private key.

### BRIEF DESCRIPTION OF THE DRAWINGS

The present disclosure is explained in greater detail with reference to the following figures. The following is shown:

FIG. 1: a schematic representation of a field device with a plurality of modules and a list of module manufacturers classified as trustworthy,

FIG. 2: a schematic representation of a field device with a plurality of modules in which a module of an unknown manufacturer has been added,

FIG. 3: a schematic representation of a field device with a plurality of modules, in which the field device enables itself as the manufacturer as it were, and

FIG. 4 a flowchart visualizing the method according to the present disclosure and its embodiments.

### DETAILED DESCRIPTION

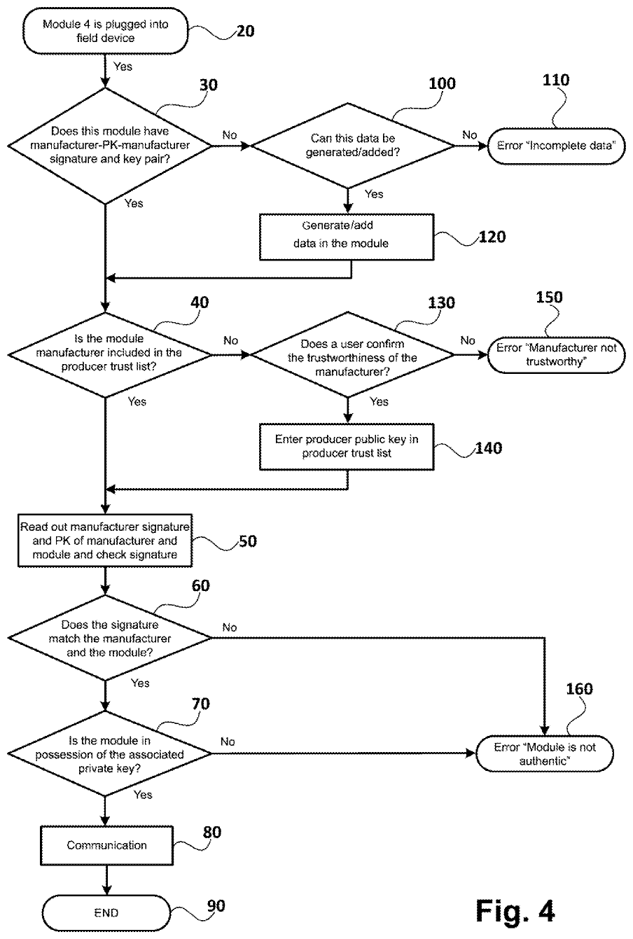

FIG. 1 shows a schematic representation of a field device FG with a plurality of modules Mk with k=1, 2, 3 and a list PTL with public keys H, V1 of module manufacturers classified as trustworthy. Two of the electronic modules M1, M2 are manufactured by the original manufacturer; one module M3 originates from an authorized manufacturer (vendor 1) classified as trustworthy. Because both the original manufacturer and the module manufacturer(s) classified as trustworthy are authorized manufacturers, for the sake of simplicity the abbreviation Vm is used for the public keys of authorized module manufacturers in the patent claims and in the description of FIG. 4, and the abbreviation vm is used for the corresponding private keys, where m=1, 2, . . . I.

In addition to its own key pair (Q, q), the list PTL with the public keys H, V1 of the module manufacturers classified as trustworthy is stored in the field device FG. In addition to its own key pair (Pk, pk), each electronic module Mk contains the public key H, V1 of the corresponding module manufacturer and the public key h(P1), h(P2), v1(P3) of the electronic modules Mk encrypted with the corresponding private key h, v1 of the module manufacturer. The public keys h(P1), h(P2), v1(P3) of the electronic modules Mk encrypted with the corresponding private keys h, vm of the module manufacturer are also referred to as manufacturer signatures. The encryption itself is marked with the letter E in FIG. 1 to FIG. 3.

The key pair (Q, q) of the field device FG may serve to enable the field device FG to be configured with respect to other field devices as an authentic field device FG of the original manufacturer or an authorized manufacturer. However, for the recognition of whether or not an electronic module Mk originates from an authorized manufacturer and can thus be incorporated into the communication necessary for the operation of the field device, the key pair (Q, q) only has relevance in the case where a manufacturer signature q(Pk) for an electronic module Mk is to be generated. This is necessary because the electronic modules Mk themselves do not have any information about which manufacturer is trustworthy or untrustworthy. However, it is possible for the authorized manufacturer—as already mentioned above—to install a corresponding add vendor ticket directly onto the electronic module Mk.

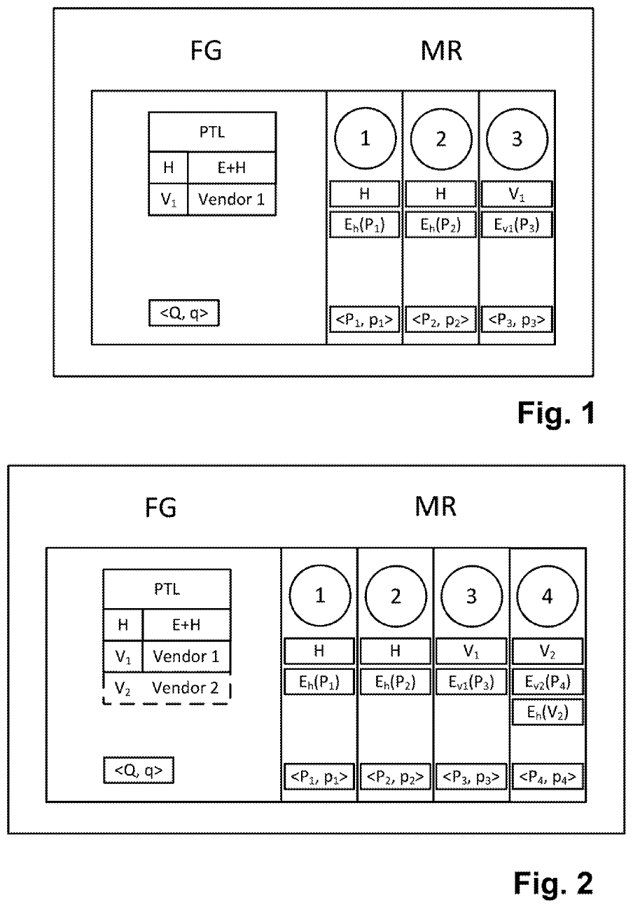

FIG. 2 is a schematic representation of a field device FG having a plurality of modules Mk in which a module M4 of a manufacturer unknown to date has been added. The manufacturer has a public key V2 which, at the time of installation of the electronic module M4, has not yet been entered in the list PTL of the manufacturers classified as trustworthy. However, the manufacturer's public key V2 is signed by one of the manufacturers classified as trustworthy in the list, in this case by the original manufacturer's private key h. The public key of the manufacturer V2 is recorded in the list PTL of the manufacturers classified as trustworthy if, for example, an authorized person logs in at the field device FG and adds the new manufacturer's public key V2 to the list PTL.

Furthermore, the electronic module M4 has the manufacturer signature v2(P4) and the key pair (P4, p4) assigned to the electronic module M4.

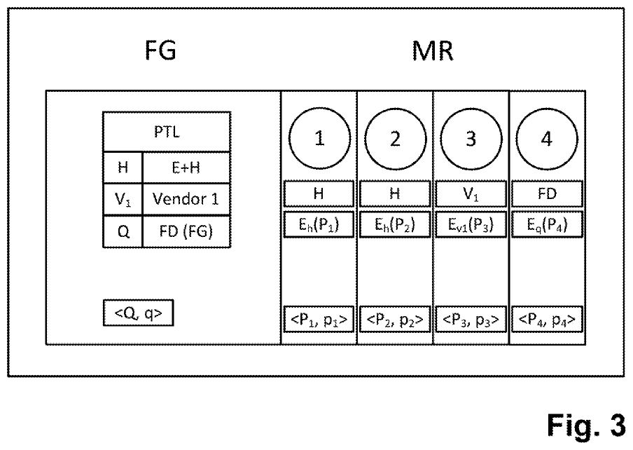

FIG. 3 shows a schematic representation of a field device FG having a plurality of modules Mk. In this case, the case is visualized that the field device FG, as it were, enables itself as the manufacturer. The field device FG signs the added module M4—it thus encrypts the public key P4 of the electronic module M4 with its private key q—transfers the manufacturer signature q(P4) to the electronic module M4, so that the electronic module M4 can subsequently be identified with respect to the field device FG. Furthermore, the field device FG must add its public key Q to the list PTL of the manufacturers classified as trustworthy. With this procedure, the field device FG subsequently accepts all electronic modules Mk signed thereby.

An alternative to this would be that the field device FG, in addition to its list PTL with the manufacturers classified as trustworthy, has a list MTL with the electronic modules classified as trustworthy. In this case, the manufacturer signature q(P4) of the electronic module M4 can be omitted. A method for ensuring that only electronic modules Mk classified as trustworthy are used in a field device FG is in other respects described in detail in the applicant's patent application filed at the same time as this patent application.

FIG. 4 shows a flowchart that displays the method according to the present disclosure and its embodiments. During production or during ongoing operation of the field device FG, either an electronic module MK is exchanged at point 20 or a new module M4 (FIG. 2) is plugged in. Because the exchanged or added electronic module Mk, M4 is included in the communication required for the operation of the field device FG only if it is ensured that the electronic module Mk originates from an authorized manufacturer V1 and is authentic in this sense, the origin of the electronic module Mk must be verifiable.

Under program point 30, a check is made in a first step as to whether the exchanged or added electronic module Mk has the following data elements:

a) the manufacturer's public key Vm—this is requested by the field device FG in order to determine the identity of the manufacturer and to verify whether the manufacturer is classified as trustworthy,

b) the key pair Pk, pk assigned to the electronic module Mk—its cryptographic identity—consisting of public key Pk and private key pk,

c) the manufacturer signature vm(Pk)—that is to say the public key Pk of the electronic module Mk encrypted with the manufacturer's private key vm.

If the availability of the aforementioned data elements is affirmed at program point 30, a check is made at program point 40 as to whether the public key Vm of the manufacturer of the electronic module Mk is listed in the list PTL of the manufacturers classified as trustworthy that is assigned to the field device FG. Upon positive output of the verification, it appears that it is an electronic module Mk of a trustworthy manufacturer. This assumption is to be proven below.

The required measures for verification are named under program point 50: The field device FG requests the manufacturer signature vm(Pk) and the public key Pk of the electronic module Mk.

At program point 60, a check is made as to whether the signature vm(Pk) matches an authorized manufacturer of the module Mk. This check is positive if the public key Pk of the electronic module Mk signed by the manufacturer with its private key vm can be decrypted with the manufacturer's public key Vm. It can then be assumed that the one which has written the signature vm(Pk) into the module Mk has been in possession of the private key vm of an authorized manufacturer. Thus, in confidence that the private key vm is not/has not been compromised, the public key Pk of the electronic module Mk must have been signed by this authorized manufacturer.

At program point 70, a check is then made as to whether the electronic module MK is also in possession of the associated private key pk. This third step can ensure that the exchanged or added electronic module Mk and the public key Pk of the electronic module Mk also actually belong together. This last check is then carried out by means of the challenge/response method with or without hashing.

As a challenge, the exchanged or added module Mk encrypts a message m sent by the field device FG using its own private key pk and sends the signed message pk(m) as a response to the field device FG. The field device FG decrypts the signature pk(m) using the existing public key Pk of the electronic module Mk and expects as a result the unencrypted message m. If this is so, it can clearly be concluded that the electronic module Mk must be in possession of the private key pk. Consequently, the public key Pk must also belong to the private key pk of the electronic module Mk.

Only if a positive result is obtained in each case in the aforementioned checks is the electronic module Mk found to be authentic—its origin from a manufacturer classified as trustworthy is proven—and included in the communication required for the operation of the field device FG (program point 80); the program is terminated at point 90.

If the check at program point 30 indicates that the exchanged or added electronic module Mk does not have the following data elements: public key Vm of the manufacturer, the key pair Pk, pk assigned to the electronic module Mk and the manufacturer signature vm(Pk)—that is to say the public key Pk of the electronic module Mk that is encrypted with the manufacturer's private key vm—a check is made at program point 100 as to whether these data elements can possibly be generated or added. If the check at program point 100 indicates that no generation or addition of the data elements is possible, then at program point 110 the error message “Incomplete data” is output; subsequently, the check we terminated. If the data elements can be generated or added at program point 120, the check is continued at program point 40.

If the check at program point 40 indicates that the public key Vm of the module manufacturer is not entered in the list PTL of the manufacturers classified as trustworthy, an authorized user/a service technician can still confirm the trustworthiness of the module Mk at program point 130. Alternatively, an add vendor ticket may also be present in the field device FG or in the electronic module Mk. If this verification is made, the manufacturer's public key Vm is recorded in the list of the manufacturers classified as trustworthy (program point 140). If the trustworthiness is not verified at program point 130, the error message “Manufacturer not trustworthy” is generated at program point 150 and the check is ended.

If the checks at one of the program points 60, 70 indicate that the signature vm(Pk) does not match the manufacturer or the electronic module Mk or that the electronic module Mk is not in possession of the associated private key pk, then the error message: “Module is not authentic” is output (program point 160). A communication required for the operation of the field device is then ruled out.

1. A method for verifying the authentic origin of electronic modules of a modular field device in automation technology,
wherein each manufacturer of an electronic module of the field device classified as trustworthy is assigned a key pair consisting of a public key and a private key, and wherein the public keys of the manufacturers classified as trustworthy are stored in a list in the field device or in a unit communicating with the field device,
wherein each electronic module of the field device contains, in addition to a suitable key pair characterizing the electronic module as trustworthy and consisting of a public key and a private key, the manufacturer's public key and a manufacturer signature, wherein the manufacturer signature confirms the public key of the electronic module as trustworthy,
wherein the method has the following method steps:
when an electronic module is exchanged or added, the field device or the unit communicating with the field device checks:
whether the exchanged or added electronic module has a key pair and a manufacturer signature,
whether the public key of the manufacturer of the electronic module is listed in the list with the public keys of the manufacturers classified as trustworthy,
whether the manufacturer signature matches the manufacturer and the electronic module,
whether the electronic module is in possession of the correct private key,
a communication or interaction of the exchanged or added electronic module with the field device or another electronic module relating to the functionality of the field device is permitted if the check is concluded with a positive result.

2. The method according to claim 1, comprising the following method step:
in order to check whether the manufacturer signature matches the manufacturer and the exchanged or added electronic module, the manufacturer signature, the manufacturer's public key and the public key of the electronic module are read out and checked.

3. The method according to claim 1, comprising the following method step:
if the manufacturer signature of the exchanged or added electronic module can be decrypted with the manufacturer's public key, it is ensured that the public key of the electronic module originates from a trustworthy manufacturer.

4. The method according to claim 3, comprising the following method steps:
checking whether the exchanged or added electronic module with which the field device or the unit communicates and the public key of the electronic module also actually belong together is performed via a challenge/response method.

5. The method according to claim 4, comprising the following method steps:
from the field device or the unit communicating with the field device, an arbitrary message is sent as a challenge to the exchanged or added electronic module with the request for signature creation or encryption,
the exchanged or added electronic module signs or encrypts the message with its private key and returns the signed message as a response to the field device or the unit,
the field device or the unit decrypts the signed message using the public key of the exchanged or added electronic module and receives the message upon positive verification.

6. The method according to claim 1, comprising the following method step:
if the check indicates that the exchanged or added electronic module has no manufacturer signature or no key pair, a check is made as to whether a manufacturer signature and/or a key pair can be generated or provided for the electronic module,
wherein, in the event that the manufacturer signature and/or the key pair is provided or generated by another electronic module, the manufacturer signature and/or the key pair is transferred to the exchanged or added electronic module.

7. The method according to claim 6, comprising the following method step:
in the event that the electronic module has no manufacturer signature and/or no suitable key pair or that no manufacturer signature and/or no suitable key pair can be generated for the electronic module, the electronic module remains excluded from the communication.

8. The method according to claim 1, comprising the following method steps:
if the check indicates that the exchanged or added electronic module has the manufacturer signature and the appropriate key pair, but that the manufacturer's public key is not stored in the list, the manufacturer's public key is assigned to the list if an authorized person confirms the trustworthiness of the electronic module manufacturer.

9. The method according to claim 1, comprising the following method steps:
if a manufacturer signature and suitable key pair can be generated for the electronic module, the data are assigned to the electronic module or stored in the electronic module.

10. The method according to claim 1, comprising the following method steps:
the electronic modules are each provided with a suitable key pair by an authorized manufacturer, the original manufacturer or a third party authorized by the original manufacturer, during the production process or during a service visit, and
the public keys of the authorized manufacturers are stored in the list.

11. The method according to claim 1, comprising the following method step:
when an electronic module is exchanged, the public key of the authorized manufacturer is deleted from the list.

12. The method according to claim 1, comprising the following method step:
the check is carried out during ongoing operation of the field device.

13. The method according to claim 1, comprising the following method step:
instead of the public key of the authorized manufacturer, a derivation is used.

14. The method according to claim 1, comprising the following method steps:
the manufacturer signature vm is calculated using an additional intermediate step: before encryption with the manufacturer's private key, a hash value is determined.

15. The method according to claim 1,
wherein plug-in modules with circuit boards or sensors with a digital connection are used as the electronic modules.
